(19) United States
(12) Patent Application Publication
(10) Pub. No.: US 2020/0130922 A1
(43) Pub. Date: Apr. 30, 2020

(54) CONTROL DEVICE FOR OPENING/CLOSING A VALVE OF A VALVED CONTAINER, ASSEMBLY COMPRISING A VALVED CONTAINER AND SUCH A CONTROL DEVICE

(71) Applicant: FILLON TECHNOLOGIES, FAVEROLLES (FR)

(72) Inventors: Aurélien BRULE, CHARTRES (FR); Clark GOODMAN, LEVES (FR)

(21) Appl. No.: 16/612,616

(22) PCT Filed: May 7, 2018
(86) PCT No.: PCT/FR2018/051147

§ 371 Date: Nov. 11, 2019

(30) Foreign Application Priority Data
May 16, 2017 (FR) 1754291

(51) Int. Cl. B65D 83/62; B65B 3/04

(52) U.S. Cl. CPC B65D 83/62; F16K 31/082; B65B 3/045

(57) ABSTRACT

A control device (1) for controlling opening/closing of a valve (16) of a valved container (11), said valve (16) comprising a valve body (17) provided with an orifice (18), a shutter (19) for shutting the orifice (18), the shutter being made at least in part out of a magnetic material, and a return member (20) for returning the shutter (19) of the valve (16) into the closed position of said orifice (18), said device (1) including at least one location (3) for receiving the valve (16) of said container (11), said location (3) comprising a housing (31) into which the valve (16) of the container (11) is suitable for being inserted, and a control system (5) for controlling opening of the valve (16), which system is suitable for being positioned at least in part around said location (3), said control system (5) being configured to hold the shutter (19) of the valve (16) in a position in which the orifice (18) of the valve (16) is open when the valve (16) is in its state in position in said location (3). The control system (5) has at least one permanent magnet (6) suitable for exerting a force of attraction or of repulsion on the shutter (19) in the direction for opening the shutter (19).

### FIELD OF THE INVENTION

The invention relates to a control device for controlling opening/closing of a valve of a valved container, and also to an assembly comprising a valved container and such a control device.

The invention relates more particularly to a control device for controlling opening/closing of a valve of a valved container, said valve comprising a valve body provided with an orifice, a shutter for shutting the orifice, the shutter being made at least in part out of a magnetic material and being mounted inside the valve body to be movable between a position in which the orifice is open and a position in which the orifice is closed, and a return member for returning the shutter of the valve into the closed position of said orifice, the device including at least one location for receiving the valve of said container, said location comprising a housing into which the valve of the container is suitable for being inserted, at least in part, and a control system for controlling opening of the valve, which system is suitable for being positioned at least in part around said location, said control system being configured to hold the shutter of the valve in the position in which the orifice of the valve is open when the control system is in its state in position around said location and when the valve is in its state in position in said location.

### PRIOR ART

Valves fitted with a shutter/plunger assembly made of a magnetic material are known, as shown in Patent EP 2 135 668 or Patent DE 3 409 142.

In order to enable such a valve to open, use is made of a coil capable of inducing a magnetic field. When electrically powered, this coil, which is also referred to as a “solenoid”, is capable of inducing a magnetic field.

The control system is thus an electromagnetic system requiring an electrical power supply for the control element, i.e. specifically a coil or solenoid. As a result, such a control system cannot be used in a so-called “ATEX” zone (i.e. having an explosive atmosphere) without taking major protective measures in order to eliminate any risk of explosion, thereby making the assembly particularly burdensome and technically complicated to develop.

### OBJECT AND SUMMARY

An object of the invention is to provide a control device of the above-specified type of design that enables it to be used without extra cost and without risk in an explosive atmosphere.

For this purpose, the invention provides a control device for controlling opening/closing of a valve of a valved container, said valve comprising a valve body provided with an orifice, a shutter for shutting the orifice, the shutter being made at least in part out of a magnetic material and being mounted inside the valve body to be movable between a position in which the orifice is open and a position in which the orifice is closed, and a return member for returning the shutter of the valve into the closed position of said orifice, said device including at least one location for receiving the valve of said container, said location comprising a housing into which the valve of the container is suitable for being inserted, at least in part, and a control system for controlling opening of the valve, which system is suitable for being positioned at least in part around said location, said control system being configured to hold the shutter of the valve in the position in which the orifice of the valve is open when the control system is in its state in position around said location and when the valve is in its state in position in said location, the device being characterized in that the control system has at least one permanent magnet suitable for exerting a force of attraction or of repulsion on the shutter in the direction for opening the shutter.

Eliminating the coil and replacing it with magnets only serves to overcome the drawbacks of the state of the art.

In an embodiment of the invention, the at least one permanent magnet is a magnet of neodymium type. This makes it possible to have magnets that are sufficiently powerful to open the orifice of the valve, without harming the sealing of the valve when the orifice is in its closed position.

In an embodiment of the invention, the control system comprises at least two permanent magnets positioned facing each other and spaced apart from each other by the housing defined by said valve reception location. The presence of at least two magnets provides a better guarantee of obtaining the desired result.

In an embodiment of the invention, the at least one permanent magnet is mounted to be movable along said location.

In an embodiment of the invention, the device includes movement drive means for driving the at least one permanent magnet to move along said location.

This manual or automatic drive of the at least one permanent magnet of the control system along said location allows the valve to pass from a closed position of the orifice to an open position of the orifice. Specifically, the stroke of the at least one permanent magnet along said location is selected to make it possible, along a segment of the stroke, for the at least one permanent magnet to exert a magnetic force of attraction or of repulsion on the shutter that is greater than the return force exerted on the shutter by the return member of the valve so as to enable the shutter to move into a position corresponding to the open position of the orifice of the valve, and along another segment of the stroke, for the at least one permanent magnet to exert a magnetic force of attraction or repulsion on the shutter that is less than the return force exerted on the shutter by the return member of the valve in order to enable the shutter to be returned to a position corresponding to the closed position of the orifice. This results in operation that is simple.

In an embodiment of the invention, the means for driving movement of the control system comprises an actuator, such as a jack, preferably of pneumatic type. It thus continues to be possible to use the device in an explosive atmosphere.

In an embodiment of the invention, the housing defined by the location for receiving the valve is in the form of an elongate cavity open at least at one of its ends, said open end being suitable for forming the opening for inserting the valve into said housing, said open end being provided with a spring suitable for being compressed when the valve is in its state inserted in said housing. The presence of such a spring enables the valve to be returned to a position extending at least in part from the housing and in which the force of attraction or of repulsion exerted by the at least one magnet on the shutter is less than the return force exerted by the return member on the shutter returning it to the position in which the orifice of the valve is closed, such that the valve is in said closed position.

In an embodiment of the invention in which the container comprises a flexible pouch that is deformable under the action of pressure exerted on the outside surface of the pouch to enable the pouch to be emptied when the pouch is in the compressed state and the orifice of the valve is open, the device is characterized in that in order to form an installation for emptying the pouch, it comprises a stand fitted with a pressurized gas feed circuit that is connectable to a source of gas under pressure, the location for receiving the valve of the device and the control system for controlling opening of the valve being arranged at least in part on said stand, and the pressurized gas feed circuit that is connectable to a source of gas under pressure being suitable for generating pressure on the outside surface of the pouch of the container when the valve of the container is in its state in position in said location for receiving the valve of the device.

In an embodiment of the invention in which said container comprises both a deformable flexible pouch that is refillable with liquid via a filler orifice and also outer packaging for the pouch, said pouch being a compressible pouch that can be shrunk inside the outer packaging under the action of pressure exerted on the outside surface of the pouch so as to enable the pouch to be emptied when the pouch is in the compressed state and the orifice of the valve is open, the device is characterized in that in order to form an installation for assisting in refilling the pouch with liquid, it comprises a stand fitted with a closable circuit for feeding gas under pressure that is connectable to a source of gas under pressure, the location for receiving the valve and the control system for controlling opening of the valve of the device being arranged at least in part on said stand, and the closable circuit for feeding gas under pressure that is connectable to a source of gas under pressure comprising a coupling suitable for positioning at least in part around the location for receiving the valve in a position in which it covers a zone of the location for receiving the valve. This zone of the location for receiving the valve covered by the coupling corresponds to the zone that is suitable for being occupied at least in part by the orifice of the valve when the valve is in its state arranged inside said location so as to enable the pouch of the container to be fed with gas in the direction for inflating the pouch when the valve is in its state positioned in said location and the orifice of the valve is in the open position.

In an embodiment of the invention, the device is in the form of a fluid spray gun and comprises a hollow base body fitted with a handle, a trigger coupled to said base body and mounted to move relative to said base body, and at least one fluid passage arranged in the base body and/or the handle, the location for receiving the valve of the device being formed at least by the or a cavity of the hollow base body of the fluid spray gun, and the control system for controlling opening of the valve of the device being carried by the trigger.

The invention also provides an assembly comprising a valved container and a control device for controlling opening/closing of the valve, said valve comprising a valve body provided with an orifice, a shutter for shutting the orifice, the shutter being made of magnetic material and being mounted to move inside the valve body between an open position of the orifice and a closed position of the orifice, and a return member for returning the shutter of the valve into the closed position of said orifice, the assembly being characterized in that the device for controlling opening/closing of the valve is of the above specified type.

Preferably, the body of the valve is in the form of a glove finger that is provided at its end with an opening forming the orifice of the valve, and the shutter is slidably mounted inside said valve body.

In an embodiment of said assembly, the housing defined by the location for receiving the valve is in the shape of an elongate cavity that is open at at least one of its ends, this open end being suitable for forming the opening for inserting the valve into the inside of said housing, and when the valve is in its state inserted at least in part in the housing, it is movably mounted to slide inside said housing.

In said assembly, said container comprises both a deformable flexible pouch that is refillable with liquid via a filler orifice and also outer packaging for the pouch, said pouch being a compressible pouch that can be shrunk inside the outer packaging under the action of pressure exerted on the outside surface of the pouch so as to enable the pouch to be emptied when the pouch is in the compressed state and the orifice of the valve is open.

In an embodiment of said assembly, in order to form an installation for assisting in refilling the pouch with liquid, the control device for controlling opening/closing of the valve comprises a stand fitted with a closable circuit for feeding gas under pressure and connectable to a source of gas under pressure, the location for receiving the valve and the control system for controlling opening of the valve of the device being arranged at least in part on said stand, and the closable circuit for feeding gas under pressure and connectable to a source of gas under pressure comprising a coupling suitable for positioning at least in part around the location for receiving the valve when in a position in which it covers a zone of the location for receiving the valve, this zone of the location for receiving the valve and suitable for being covered by the coupling corresponding to the zone that is suitable for being occupied at least in part by the orifice of the valve when the valve is in its state arranged inside said location so as to enable the pouch of the container to be fed with gas in the direction for inflating the pouch, when the valve is in its state positioned in said location and the orifice of the valve is in the open position.

In an embodiment of said assembly, in order to form an installation for emptying the pouch, the device for controlling opening/closing of the valve comprises a stand fitted with a pressurized gas feed circuit that is connectable to a source of gas under pressure, the location for receiving the valve of the device and the control system for controlling opening of the valve being arranged at least in part on said stand, and the pressurized gas feed circuit that is connectable to a source of gas under pressure being configured to generate pressure on the outside surface of the pouch of the container when the valve of the container is in its state in position in said location for receiving the valve of the device.

### BRIEF DESCRIPTION OF THE FIGURES

The invention can be well understood on reading the following description of embodiments, given with reference to the accompanying drawings, in which:

FIG. 1 is a diagrammatic view of the opening/closing control device, the valve being positioned outside the valve reception location of the control device in order to avoid subjecting the shutter of the valve to the action of the magnets of the control system.

FIG. 2A is a diagrammatic view of the opening/closing control device, the valve being positioned inside the valve reception location of the control device and being subjected to the action of the magnets of the control system in order to hold the shutter of the valve in the valve orifice open position.

FIG. 2B is a diagrammatic view of the FIG. 2A opening/closing control device in a position in which a spring is arranged at one end of the housing defined by the valve reception location.

FIG. 3 is a section view of a valved container with the valve orifice in its closed position.

FIG. 4 is a perspective view of the valved container with the stopper in the removed state.

FIG. 5 is two fragmentary sectional views of the valve in the valve orifice closed position (top view) and in the valve orifice open position (bottom view).

FIG. 6 is a section view of an opening/closing control device in the form of an installation for assisting in refilling the pouch with liquid.

FIG. 7 is a perspective view of an opening/closing control device in the form of an installation for assisting in refilling the pouch with liquid, with the valve coupling being in the non-coupled state.

FIG. 8 is a perspective view of an opening/closing control device in the form of an installation for assisting in refilling the pouch with liquid, with the valve coupling being in the coupled state.

FIG. 9 is a perspective view of an opening/closing control device that is in the form of an installation for emptying the pouch of a container, associated with two detail views of the valve reception location.

FIG. 10 is a perspective view of an opening/closing control device that is in the form of an installation for emptying the pouch of a container, associated with a detailed view of the valve reception location in an embodiment in which the magnets are movable along said location.

FIG. 11A is a perspective view of an opening/closing control device that is in the form of a spray gun with its trigger in the released state.

FIG. 11B is a perspective view of an opening/closing control device that is in the form of a spray gun with its trigger in the pulled state.

### DETAILED DESCRIPTION

As mentioned above, the invention relates to a control device 1 for controlling opening/closing of a valve 16 of a valved container 11, and to an assembly comprising the valved container 11 and the control device 1.

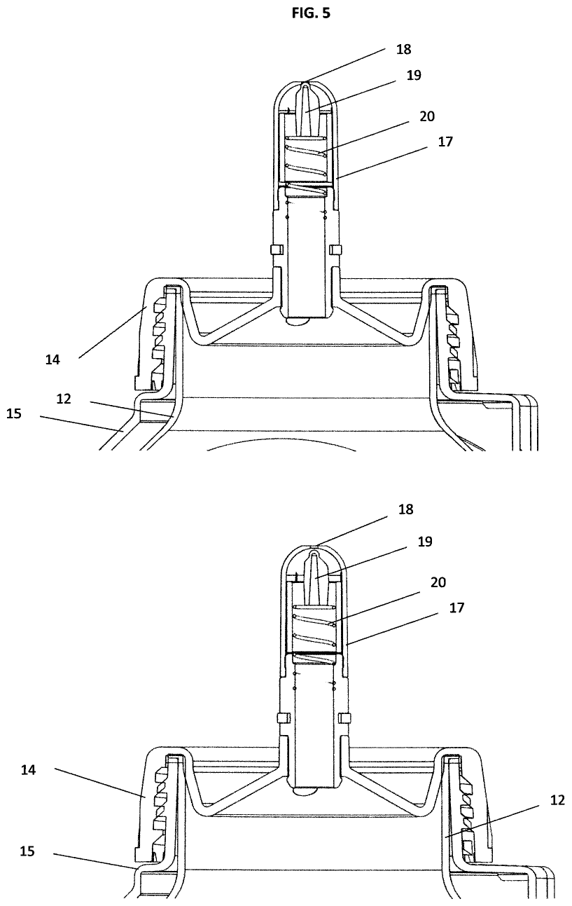

This opening/closing control device 1 is intended more particularly for opening/closing a valve of the type shown in FIG. 5.

The valve 16 comprises a valve body 17 provided with a shutter 19 for shutting its orifice 18, the shutter being made at least in part out of a magnetic material and being movably mounted inside the valve body 17 to move between a position in which the orifice 18 is open and a position in which the orifice 18 is closed, together with a return member 20 for returning the shutter 19 of the valve 16 to the position in which said orifice 18 is closed.

In the example shown, the body 17 of the valve 16 is in the form of a glove finger that is provided at its end with an opening forming the orifice 18 of the valve 16, and the shutter 19 is slidably mounted inside the valve body 17. Via its base, the finger communicates with the container to which it is fitted.

The return member 20 is a helical spring that extends between the shutter and the valve body. The detail of the inside of such a valve 16 is not described, since it is well known to persons skilled in this art.

The orifice 18 of the valve 16 is conventionally used, when in its open position, for emptying the container to which it is fitted. In the example shown, this valve 16 is fastened to a stopper 14 for closing a container 11, as described in detail below.

The control device 1 for controlling opening/closing of the valve 16 of the container 11 includes at least one location 3 for receiving the valve 16 of the container, and in association with each location 3 for receiving the valve 16, it includes a system 5 for controlling opening of the valve 16. For reasons of simplicity in the figures, there is shown each time only one location 3 and thus only one associated control system 5.

The valve reception location 3 has a housing 31 into which the valve 16 of the container 11 is suitable for being inserted axially, at least in part.

This housing 31, which is generally in the shape of an elongate cavity, may be blind or open, depending on the embodiment of the control device 1. It may be defined by a circumferential wall that is continuous or that is discontinuous so as to form a housing with an opening that is also lateral.

The device 1 also includes a control system 5 for controlling opening of the valve 16 and suitable for being positioned at least in part around said location 3. When the valve 16 is in its state positioned in said location 3, and when the control system 5 is in its state positioned around the location 3, the control system 5 is configured to hold the shutter 19 of the valve 16 in its position in which the orifice 18 of the valve 16 is open.

The control system 5 has at least one permanent magnet 6 suitable for exerting a force of attraction and of repulsion on the shutter 19 in the direction for opening the shutter 19.

In the examples shown, the control system 5 has two permanent magnets positioned facing each other and spaced apart from each other by the housing 31 defined by the valve reception location 3. These permanent magnets are magnets of the neodymium type.

The two magnets 6 are thus positioned on either side of the valve 16 when the valve 16 is in its state positioned in the location 3, such that the force exerted by the magnets is sufficient to attract the shutter 19, e.g. made of magnetic material, towards the end of the valve remote from its end having the orifice 18 of the valve 16 and referred to as its “breech”. The valve is then open.

In this configuration, the force of attraction or of repulsion exerted by the magnets on the shutter in the direction for opening the orifice 18 of the valve is greater than the force exerted on the shutter 19 by the return member 20.

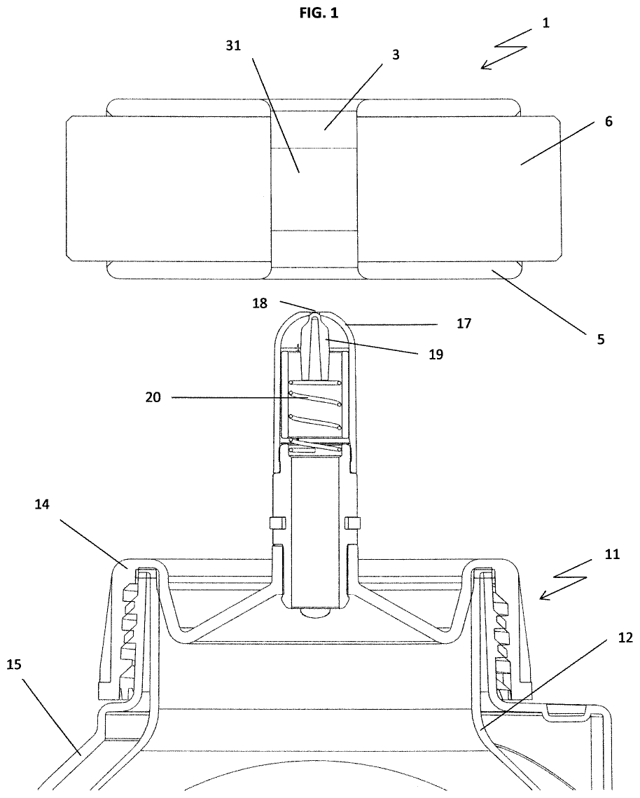

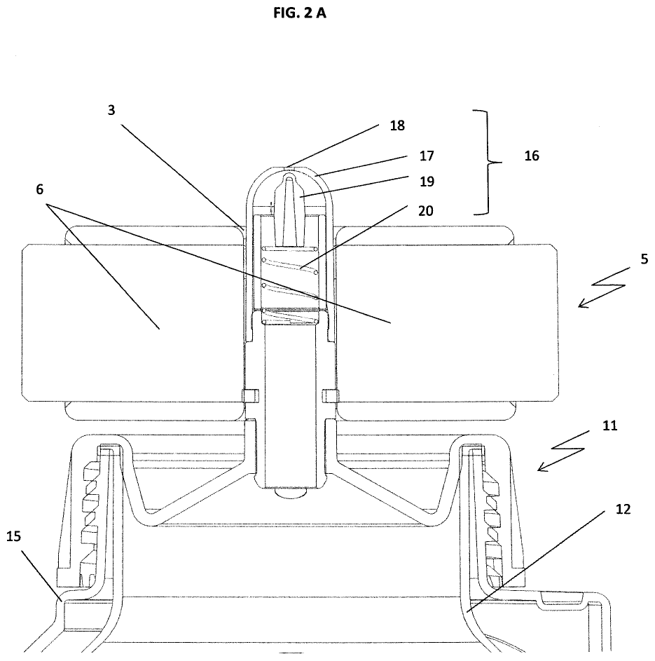

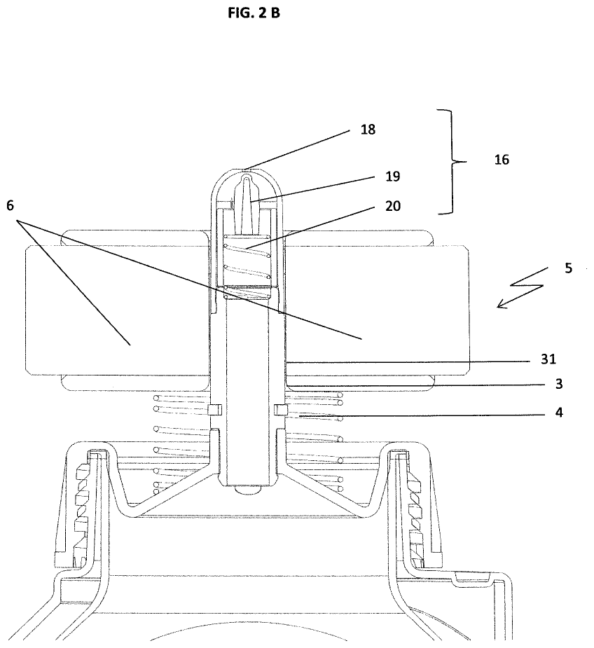

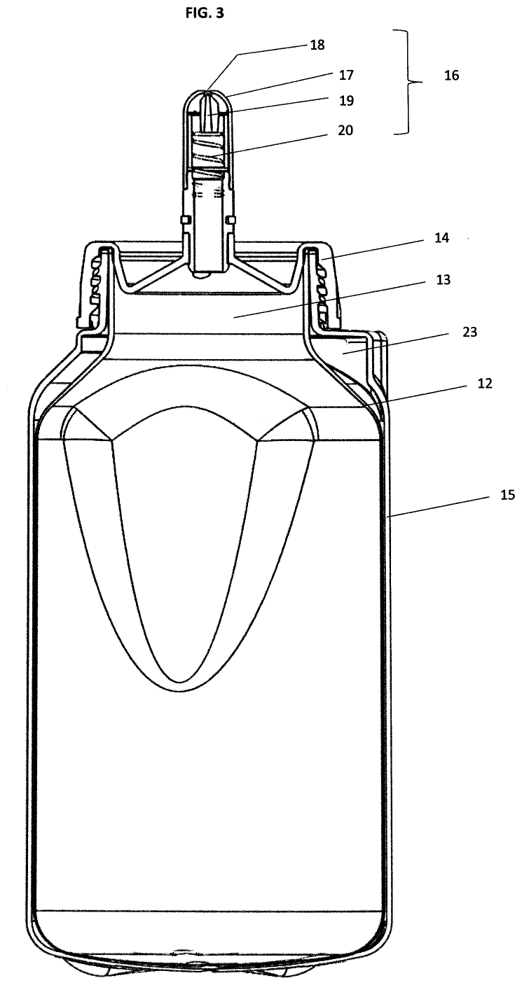

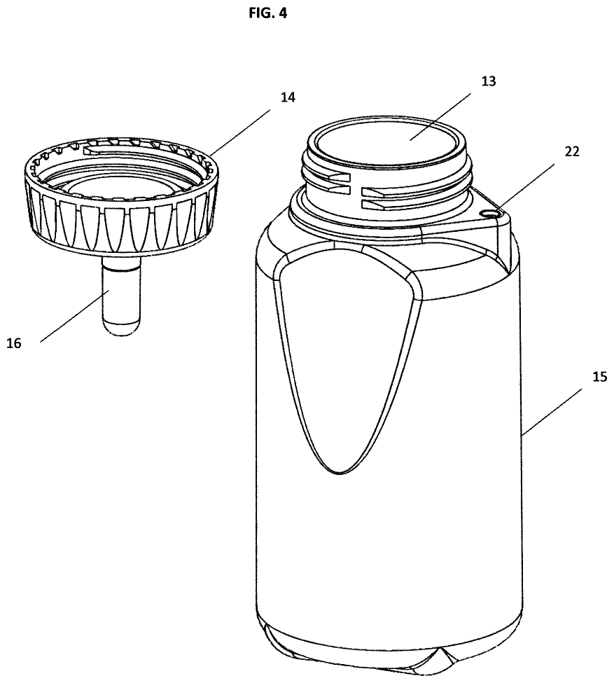

When the valve is taken away from between the magnets, the return member 20 re-closes the valve. Specifically, in this configuration, the force of attraction or of repulsion exerted by the magnets 6 on the shutter 19 in the direction for opening the orifice is less than the force exerted on the shutter 19 by the return member 20. This principle of operation is shown in FIGS. 1 and 2A, 2B. FIG. 2B differs from FIG. 2A solely by the fact that a spring 4 is fitted to an open end of the housing 31, which is in the form of an elongate cavity, the spring tending to urge the valve into its position outside the housing corresponding to the valve orifice being in the closed position. The spring 4 is thus suitable for being compressed when the valve 16 is in its state inserted in the housing 31, since the spring lies between the stopper of the container and the open end of the housing of the control device.

The magnets 6 arranged around the valve reception location 3 may be stationary relative to said location, as shown in FIGS. 1, and 2A, 2B.

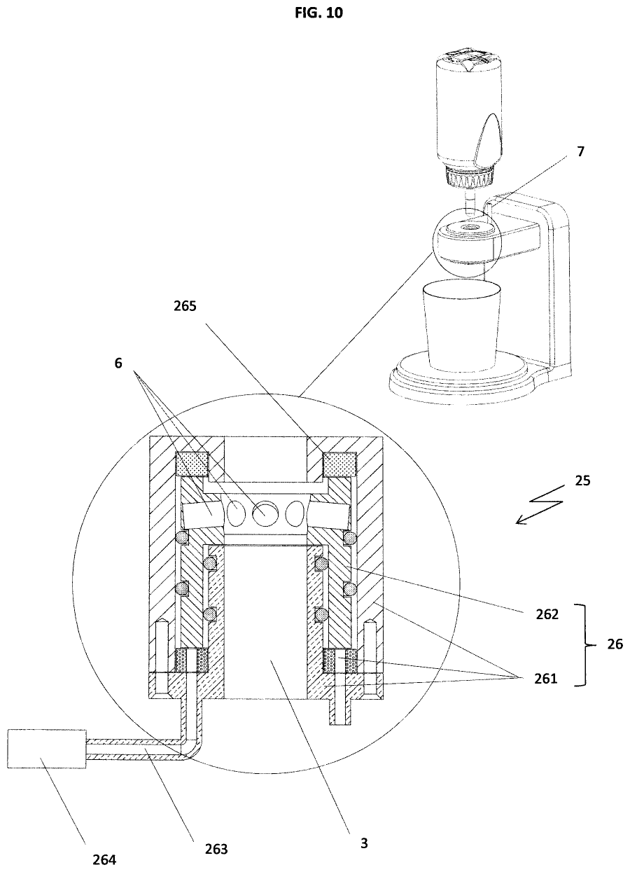

It is also possible for these magnets 6 to be movable along said location 3. Thus, rails defining a guide track for the magnets 6 may be arranged along the location 3 to enable the magnets to be moved manually along said location. In a variant, the control device 1 may include drive means 25 for moving the permanent magnets 6 along said location 3. By way of example, these movement drive means 25 of the control system 5 may comprise a pneumatic actuator 26, such as a jack. An example actuator is shown in FIG. 10.

The actuator 26 comprises an annular chamber 261 and a sleeve 262 coaxial with the chamber. Over at least a portion of its length, the sleeve is suitable for surrounding the valve reception location 3. The sleeve 262 is slidably coupled to the chamber 261.

The chamber 261 is a chamber suitable for being put under pressure, and it is connected by a closable pneumatic circuit 263 to a source of gas under pressure. The closure member 264 for closing the pneumatic circuit may be a member of the solenoid valve type. The sleeve and the chamber are equivalent respectively to the rod and to the cylinder of a pneumatic jack.

The sleeve carries the magnets 6 of the control system. Thus, under the action of the chamber being fed with pressure, as the sleeve 262 moves along the location 3 for receiving the valve 16, it tends to cause the orifice 18 of the valve to open. A spring 265 may be provided to return the sleeve 262 towards the chamber 261.

By means of such a design, when the valve is in its state positioned in stationary manner in the valve reception location 3, it can go from the closed position to the open position, and vice versa, while allowing the control device 1 to be positioned in an explosive atmosphere.

The container 11 fitted to such a base may have a wide variety of forms. Nevertheless, the container preferably comprises a flexible pouch 12 that is deformable under the action of pressure exerted on the outside surface of the pouch 12 so as to make it possible to empty the pouch 12 when the pouch 12 is in the compressed state and the orifice 18 of the valve 16 is in the open state.

In the example shown, the container 11 also comprises outer packaging 15 for the pouch 12.

In this example, this outer packaging 15, which constitutes a rigid or semi rigid shell for protecting the pouch 12, is in the form of an elongate body provided with a neck, thereby giving it the appearance of a jar. The pouch 12 is received inside of the outer packaging 15 and is pressed at least in part against the inside wall of the outer packaging 15.

The pouch 12 presents an opening surrounded by a collar, which collar is pressed against the outer peripheral edge of the neck of the jar constituting the outer packaging 15. Because the body of the pouch 12 presents a circumference that is greater than the circumference of the neck of the outer packaging, the pouch cannot move out from the outer packaging. It is also possible for the pouch 12 to be bonded locally to the outer packaging 15.

Thus, the pouch 12 is held inside the outer packaging 15.

At the neck of the outer packaging, the pouch 12 thus has an opening that constitutes the orifice 13 for filling the pouch 12 with liquid. This filling orifice 13 is closed by means of a stopper 14, which is screwed onto the neck of the outer packaging 15. The pouch could be provided with a filling orifice 13 at some other location, without going beyond the ambit of the invention.

The pouch 12 is emptied by compressing the pouch 12 under the action of pressure exerted on the outside surface of the pouch 12. This pressure may be exerted in various ways. In the examples shown, the outside surface of the pouch 12 cooperates with the inside surface of the outer packaging to define a closed space 23 that is in communication with the outside via an orifice provided in the outer packaging, and given reference 22 in the figures.

During the stage of emptying the pouch, this orifice 22 may be connected to a source of gas under pressure in order to put the closed volume under pressure.

Putting the closed volume under pressure in this way leads to the pouch 12 being compressed, thereby enabling the pouch 12 to be emptied when the orifice 18 of the valve 16 is in its open position.

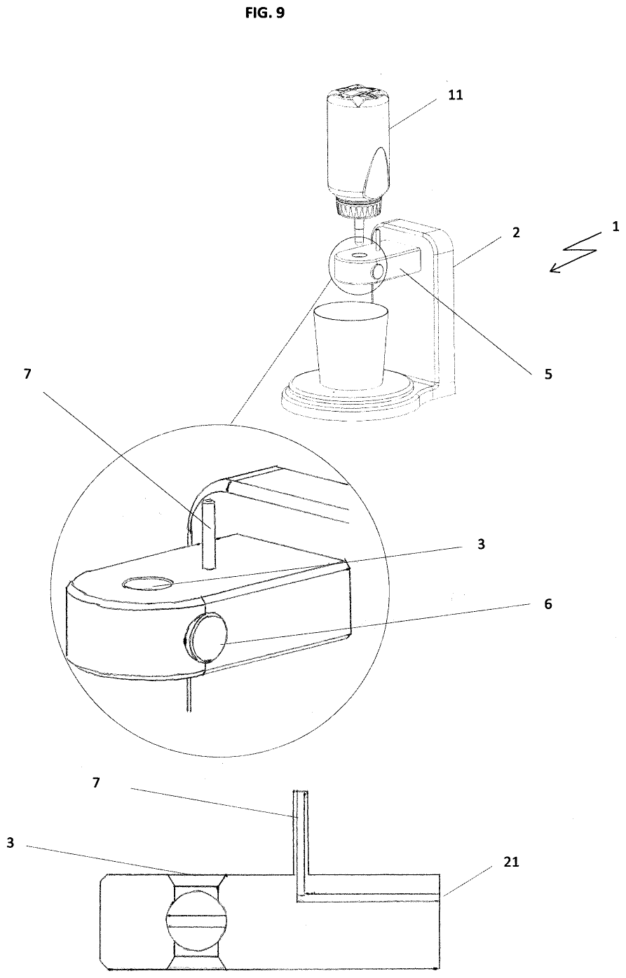

These operations of emptying the pouch and of opening the orifice may be performed using an opening/closing control device that is in the form of an installation for emptying the pouch, e.g. as shown in FIG. 9.

Under such circumstances, the opening/closing control device 1 comprises a stand 2 fitted with a pressurized gas feed circuit 7 suitable for connection to a source 21 of gas under pressure.

The location 3 for receiving the valve 16 of the device, and the system 5 for causing the valve 16 to open are provided, at least in part, on the stand 2, and the pressurized gas feed circuit 7 that is connectable to a source 21 of gas under pressure is configured to generate pressure on the outside surface of the pouch 12 of the container 11 when the valve 16 of the container 11 is in its state positioned in the location 3 for receiving the valve 16 of the device 1. In the example shown, the feed circuit 7 presents a segment of duct arranged on the stand 2 in the proximity of the location 3 of the stand 2 for receiving the valve. This duct segment of the feed circuit 7 is inserted in the orifice 22 arranged in the outer packaging 15 of the pouch 12 when the valve 16 of the container 11 is in its state positioned in the location 3 for receiving the valve 16 of the device 1 in order to feed gas under pressure to the closed space 23 defined between the outside surface of the pouch 12 and the inside surface of the outer packaging. Naturally, it is possible to devise other embodiments of the pressurized gas feed circuit 7 depending on the design of the container and on the position of the location of the compression zone of the pouch relative to said container.

While it is being emptied, the pouch 12 thus tends to shrink inside the outer packaging. Once fully shrunk inside the outer packaging 15, and in order to refill the pouch, it is necessary to redeploy it and to reposition it so that it is bearing at least in part, against the inside of the outer packaging.

To do this, it is necessary to open the orifice 18 of the valve 16 and to inflate the pouch 12 by blowing air into the inside of the pouch 12 via the orifice 18 of the valve 16 while it is in the open position.

The orifice 18 of the valve 16 is then no longer used as an orifice for emptying liquid from the pouch, but rather as an orifice for filling the pouch 12 with gas.

In order to make such filling possible, it is necessary for the orifice 22 in the outer packaging to be connected to an exhaust, assuming it was previously connected to a source of fluid under pressure.

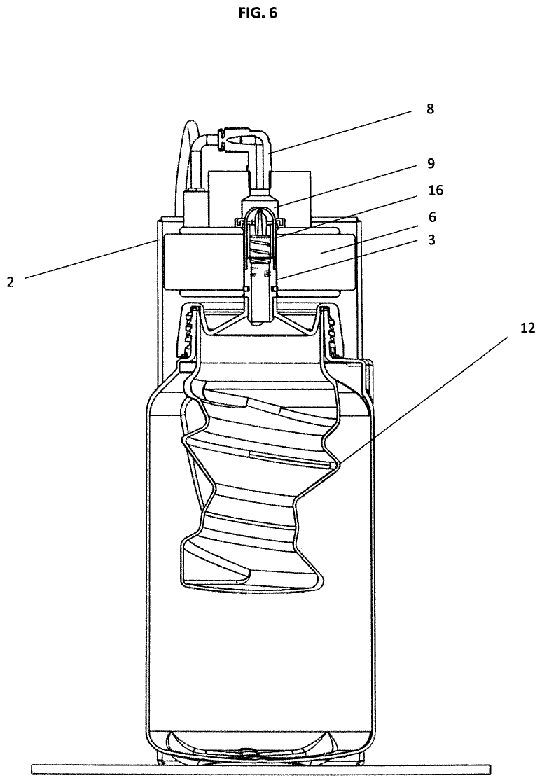

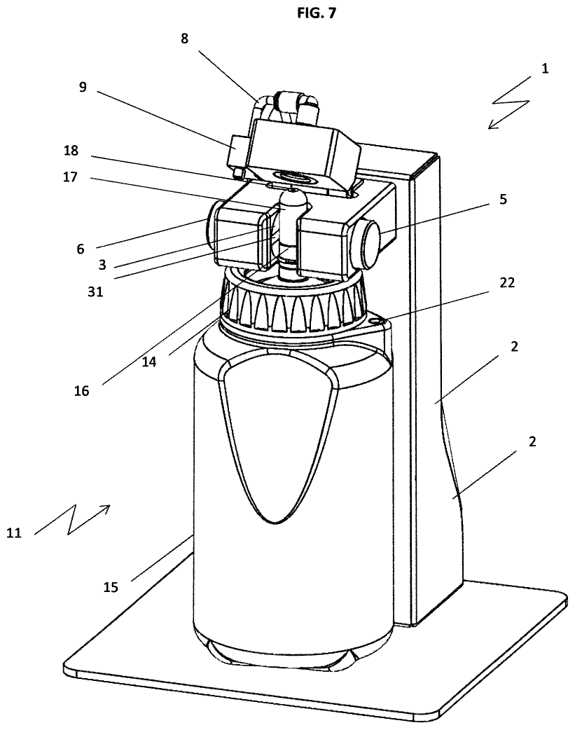

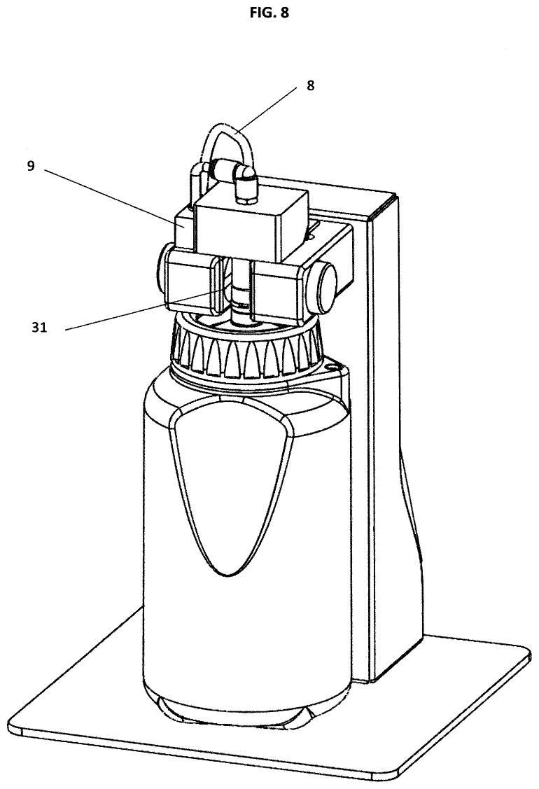

In order to be able to perform this step of inflating the pouch, it is possible to use an opening/closing control device 1 that is in the form of an installation for assisting in refilling the pouch with liquid, as shown in FIGS. 6 to 8.

This installation comprises a stand 2 fitted with a closable feed circuit 8 for feeding gas under pressure that is connectable to a source 21 of gas under pressure, with the location 3 for receiving the valve 16 and the system 5 for controlling opening of the valve 16 of the device 1 being arranged at least in part on said stand 2. The closable pressurized gas feed circuit 8 that is connectable to a source 21 of gas under pressure has a coupling 9 positioned at least in part around the location 3 for receiving the valve 16 in a position in which it covers a zone of the reception location 3 that is suitable for being occupied at least in part by the orifice 18 of the valve 16 when the valve 16 is arranged in its state inside said location 3 in order to enable the pouch 12 of the container 11 to be fed with gas in the direction for inflating the pouch 12 while the valve 16 is in its state positioned in said location 3 and the orifice 18 of the valve 16 is in the open position.

The coupling 9 forms at least the portion of the gas flow pipe that terminates at one end in a pivotal endpiece that covers the portion of the valve that projects from the through housing 31. At its other end, this gas flow pipe is suitable for connecting to a source of gas under pressure, in particular to a compressor or to some other generator of compressed air.

The endpiece of the pipe thus forms the portion of the coupling 9 that is pivotally mounted on the stand 2 in order to move the coupling 9 between a position spaced apart from the location 3 for receiving the valve 16 and the position close to the location 3 for receiving the valve 16 in which it is placed at least in part around the valve reception location 3 and covers the zone of the location 3 for receiving the valve of the container 11 that is suitable for being occupied by the orifice 18 of the valve when the valve 16 is placed in its state inside said location 3. This pivotal portion of the coupling closes the end of the housing 31.

The gas flow pipe fitted with the coupling 9 is a connection that is closable by a closing member mounted to move between a closed position and an open position.

This closing member may be a pneumatic contactor constrained to move with the movable portion of the coupling. The closing member is configured to pass from the closed position of the coupling 9 to the open position of the coupling 9 when the coupling 9 moves towards the location 3 for receiving the valve 16.

This closing member may thus comprise a spring-biased ball occupying a position in which the resulting gas flow pipe is open when the coupling is close to the valve reception location 3.

Thus, the above-described installation operates as follows: assume that the pouch of the container has been emptied by applying pressure on the pouch, via the orifice 22 in the outer packaging, such that the pouch has shrunk inside the outer packaging.

The container is then arranged in the installation with the valve in position between the magnets.

The orifice 18 of the valve 16 is then in the open position, the shutter 19 of the orifice 18 being moved into the open position for the orifice 18 against the return member 20 under the action of a magnetic attraction or repulsion force exerted by the magnets on said shutter 19.

The pivoting portion or endpiece of the coupling 9 is pivoted to cover the end of the valve having the orifice 18 of the valve, without giving rise to direct contact between the orifice 18 of the valve and the coupling 9. This pivoting portion of the coupling may be provided internally with a sealing ring in order to isolate the orifice 18 of the valve from the outside and improve the effectiveness of inflation.

The closing member of the coupling is then in the open position. Air at low pressure, in the range 0.1 bar to 0.5 bar, is sent into the pouch via said orifice 18 of the valve 16, so as to put the pouch back into place inside the outer packaging.

Inflating the pouch generally takes ten seconds to twenty seconds. From the sound produced, the operator detects that the pouch is in place, i.e. generally pressed at least in part against the outer packaging.

It should be observed that during this operation of putting the pouch back into place, the installation does not, at any moment, come into direct contact with the liquid contained in the pouch. Specifically, even if the coupling covers the end of the valve body that has the orifice 18 of the valve, the coupling is configured so as to surround the orifice 18 of the valve without touching it, which orifice 18 might be soiled by the liquid from the content of the pouch.

It is thus possible to go from one container to another without any need to clean the installation.

Once inflation has terminated, it suffices to move the pivotal portion of the coupling away from the valve reception location. The closing member closes the pneumatic circuit. The valve of the container may be extracted from its location, with the return spring 20 then returning the shutter into its position for closing the orifice of the valve, the shutter no longer being subjected to the action of the magnets driving it into its position for opening the orifice 18 of the valve.

A new container may be installed in the installation for a new operation of inflating a pouch.

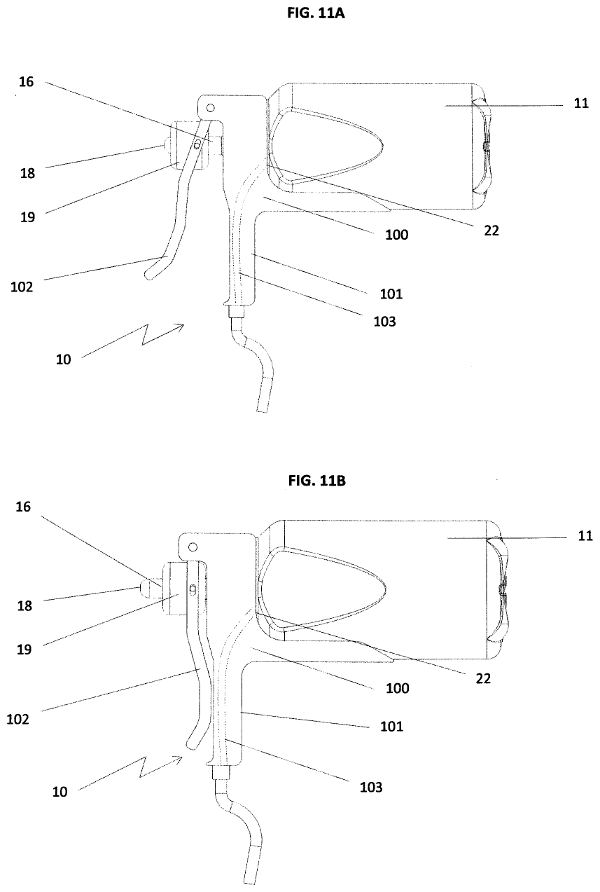

In the example shown in FIGS. 11A and 11B, the device 1 is in the form of a fluid spray gun 10 and comprises a hollow base body 100 fitted with a handle 101, a trigger 102 coupled to said base body 100 and movably mounted relative to said base body 100, and at least one fluid passage 103 provided in the base body 100 and/or the handle 101. The location 3 for receiving the valve 16 of the device 1 is formed at least by the or a cavity of the hollow base body 100 of the fluid spray gun 10, and the system for controlling opening of the valve of the device 1 is carried by the trigger 102. The location 3 for receiving the valve is extended towards the trigger.

Such a spray gun operates as follows: when the trigger 102 is pulled, it moves along the valve reception location and causes the orifice of the valve to be opened by causing the shutter to be moved under the action of the magnets fitted to the trigger. The fluid passage of the spray gun may be connected to the orifice 22 opening out into the closed volume 23 of the container so as to apply controlled compression to the pouch. The pouch can thus be emptied. In order to interrupt emptying, it suffices to release the trigger. This release causes the valve orifice to be closed by the magnets moving away from the shutter and by the shutter being returned to the closed position. In parallel, this release of the trigger can stop gas being fed to the closed volume between the pouch and the outer packaging. Once more, operation is easy and reliable.

A control device for controlling opening as described above can thus be embodied in a large number of forms.

1. A control device for controlling opening/closing of a valve of a valved container, said valve comprising a valve body provided with an orifice, a shutter for shutting the orifice, the shutter being made at least in part out of a magnetic material and being mounted inside the valve body to be movable between a position in which the orifice is open and a position in which the orifice is closed, and a return member for returning the shutter of the valve into the closed position of said orifice, said device including at least one location for receiving the valve of said container, said location comprising a housing into which the valve of the container is suitable for being inserted, at least in part, and a control system for controlling opening of the valve, which system is suitable for being positioned at least in part around said location, said control system being configured to hold the shutter of the valve in the position in which the orifice of the valve is open when the control system is in its state in position around said location and when the valve is in its state in position in said location, wherein the control system has at least one permanent magnet suitable for exerting a force of attraction or of repulsion on the shutter in the direction for opening the shutter.

2. A device according to claim 1, wherein the at least one permanent magnet is a magnet of neodymium type.

3. A device according to claim 1, wherein the control system comprises at least two permanent magnets positioned facing each other and spaced apart from each other by the housing defined by said valve reception location.

4. A device according to claim 1, wherein the at least one permanent magnet is mounted to be movable along said location.

5. A device according to claim 4, wherein said device includes movement drive means for driving the at least one permanent magnet to move along said location.

6. A device according to claim 1, wherein the housing defined by the location for receiving the valve is in the form of an elongate cavity open at at least one of its ends, said open end being suitable for forming the opening for inserting the valve into said housing, said open end being provided with a spring suitable for being compressed when the valve is in its state inserted in said housing.

7. A device according to claim 1, said container comprising a flexible pouch that is deformable under the action of pressure exerted on the outside surface of the pouch so as to allow the pouch to be emptied when the pouch is in the compressed state and the orifice of the valve is open, wherein in order to form an installation for emptying the pouch, the device comprises a stand fitted with a pressurized gas feed circuit that is connectable to a source of gas under pressure, the location for receiving the valve of the device and the control system for controlling opening of the valve being arranged at least in part on said stand, and the pressurized gas feed circuit that is connectable to a source of gas under pressure being suitable for generating pressure on the outside surface of the pouch of the container when the valve of the container is in its state in position in said location for receiving the valve of the device.

8. A device according to claim 1, comprising both a deformable flexible pouch that is refillable with liquid via a filler orifice and also outer packaging for the pouch, said pouch being a compressible pouch that can be shrunk inside the outer packaging under the action of pressure exerted on the outside surface of the pouch so as to enable the pouch to be emptied when the pouch is in the compressed state and the orifice of the valve is open, wherein in order to form an installation for assisting in refilling the pouch with liquid, it comprises a stand fitted with a closable circuit for feeding gas under pressure that is connectable to a source of gas under pressure, the location for receiving the valve and the control system for controlling opening of the valve of the device being arranged at least in part on said stand, and the closable circuit for feeding gas under pressure that is connectable to a source of gas under pressure comprising a coupling suitable for positioning at least in part around the location for receiving the valve in a position in which it covers a zone of the location for receiving the valve.

9. A device according to claim 1, wherein the device is in the form of a fluid spray gun and comprises a hollow base body fitted with a handle, a trigger coupled to said base body and mounted to move relative to said base body, and at least one fluid passage arranged in the base body and/or the handle, the location for receiving the valve of the device being formed at least by the or a cavity of the hollow base body of the fluid spray gun, and the control system for controlling opening of the valve of the device being carried by the trigger.

10. An assembly comprising a valved container and a control device for controlling opening/closing of the valve, said valve comprising a valve body provided with an orifice, a shutter for shutting the orifice the shutter being made of magnetic material and being mounted to move inside the valve body between an open position of the orifice and a closed position of the orifice, and a return member for returning the shutter of the valve into the closed position of said orifice, wherein the device for controlling opening/closing of the valve is in accordance with claim 1.

11. An assembly according to claim 10, wherein the housing defined by the location for receiving the valve is in the shape of an elongate cavity that is open at at least one of its ends, this open end being suitable for forming the opening for inserting the valve into the inside of said housing, and in that when the valve is in its state inserted at least in part in the housing, it is movably mounted to slide inside said housing.

12. An assembly according to claim 10, wherein said container comprises both a deformable flexible pouch that is refillable with liquid via a filler orifice and also outer packaging for the pouch, said pouch being a compressible pouch that can be shrunk inside the outer packaging under the action of pressure exerted on the outside surface of the pouch so as to enable the pouch to be emptied when the pouch is in the compressed state and the orifice of the valve is open.

13. An assembly according to claim 12, wherein in order to form an installation for assisting in refilling the pouch with liquid, the control device for controlling opening/closing of the valve comprises a stand fitted with a closable circuit for feeding gas under pressure and connectable to a source of gas under pressure, the location for receiving the valve and the control system for controlling opening of the valve of the device being arranged at least in part on said stand, and the closable circuit for feeding gas under pressure and connectable to a source of gas under pressure comprising a coupling suitable for positioning at least in part around the location for receiving the valve when in a position in which it covers a zone of the location for receiving the valve, this zone of the location for receiving the valve and suitable for being covered by the coupling corresponding to the zone that is suitable for being occupied at least in part by the orifice of the valve when the valve is in its state arranged inside said location so as to enable the pouch of the container to be fed with gas in the direction for inflating the pouch, when the valve is in its state positioned in said location and the orifice of the valve is in the open position.

14. An assembly according to claim 12, wherein in order to form an installation for emptying the pouch, the device for controlling opening/closing of the valve comprises a stand fitted with a pressurized gas feed circuit that is connectable to a source of gas under pressure, the location for receiving the valve of the device and the control system for controlling opening of the valve being arranged at least in part on said stand, and the pressurized gas feed circuit that is connectable to a source of gas under pressure being configured to generate pressure on the outside surface of the pouch of the container when the valve of the container is in its state in position in said location for receiving the valve of the device.
